(19) United States
(12) Patent Application Publication
(10) Pub. No.: US 2010/0115720 A1
(43) Pub. Date: May 13, 2010

(54) CLEANING APPARATUS FOR AUTOMOBILE WINDOW PANE

(76) Inventor: Cesar Acuna, Lynwood, CA (US)

Correspondence Address: L.C. BEGIN & ASSOCIATES, PLLC, 510 HIGHLAND AVENUE, PMB 403, MILFORD, MI, 48381, US

(21) Appl. No.: 12/557,933

(22) Filed: Sep. 11, 2009

Related U.S. Application Data
(60) Provisional application No. 61/112,941, filed on Nov. 10, 2008.

(51) Int. Cl. B60S 3/04

(52) U.S. Cl. 15/97.3

(57) ABSTRACT

A cleaning apparatus capable of absorbing water present between an automobile door panel and a door window pane is provided. One embodiment of the cleaning apparatus includes a cleaning member and a handle member. The cleaning member comprises a longitudinal member and an absorbing member. The absorbing member is capable of wrapping around the longitudinal member. The cleaning member is capable of being inserted between the automobile door panel and the door window pane. The handle member is perpendicularly attached to the longitudinal member at an end portion of the longitudinal member. Further, the handle member facilitates a user to insert the cleaning member between the automobile door panel and the door window pane for enabling the absorbing member to absorb water therefrom.

### CROSS REFERENCE TO RELATED APPLICATION

This application claims the benefit of U.S. Provisional Application No. 61/112,941 filed on Nov. 10, 2008, the disclosure of which is incorporated by reference.

### FIELD OF THE DISCLOSURE

The present disclosure generally relates to a cleaning apparatus, and more particularly, to a cleaning apparatus for an automobile window pane.

### BACKGROUND OF THE DISCLOSURE

People generally wash their automobiles in order to keep the automobiles neat and clean. People even spend extended amount of time to wash their automobiles so that the automobiles come out sparkly clean after the wash. Even after spending extended amount of time in washing the automobiles, many people get frustrated to see water stains on window panes when they roll the window panes down and up. The window panes get water stains because while washing an automobile, the water seeps through the gap between the door panels and the window panes, and when the windows panes are rolled down and up, the window panes get water stains.

These water stains eventually fade, but for a period of time such water stains ruin a look of a shiny, freshly cleaned automobile. In order to avoid such water stains on the window panes, people generally have to wait for some time before they may roll the window panes down and up.

Other alternative to remove such water stains from the window panes may include installing side window wipers in the automobiles. There are quite few automobile manufacturers companies which provide side window wipers for the automobiles. However, installing such side window wipers in the automobiles is expensive and unsightly.

### SUMMARY OF THE DISCLOSURE

A cleaning apparatus capable of absorbing water present between an automobile door panel and a door window pane is provided. One embodiment of the cleaning apparatus includes a cleaning member and a handle member. The cleaning member comprises a longitudinal member and an absorbing member. The absorbing member is capable of wrapping around the longitudinal member to form a sleeve. The cleaning member is capable of being inserted between the automobile door panel and the door window pane. The handle member is perpendicularly attached to the longitudinal member at an end portion of the longitudinal member. Further, the handle member facilitates a user to insert the cleaning member between the automobile door panel and the door window pane for enabling the absorbing member to absorb water therefrom.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is an exploded view of one embodiment of a cleaning apparatus; and

FIG. 2 is a perspective view of the cleaning apparatus of FIG. 1 in an assembled state; and

FIG. 3 is a perspective view of the cleaning apparatus of FIG. 2 in a utilized state.

Like reference numerals refer to like parts throughout the description of the drawings.

### DETAILED DESCRIPTION OF THE DISCLOSURE

The exemplary embodiments described herein in detail for illustrative purposes are subject to many variations in structure and design. It should be emphasized, however, that the present disclosure is not limited to a cleaning apparatus, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The term “first,” “second,” and the like, herein do not denote any order, elevation or importance, but rather are used to distinguish placement of one element over another. Further, the terms, “a” and “an” herein do not denote a limitation of quantity, but rather denote the presence of at least one of the referenced item. Unless limited otherwise, the terms “attached,” “connected,” “coupled,” and variations thereof herein are used broadly and encompass direct and indirect attachments, connections, and couplings.

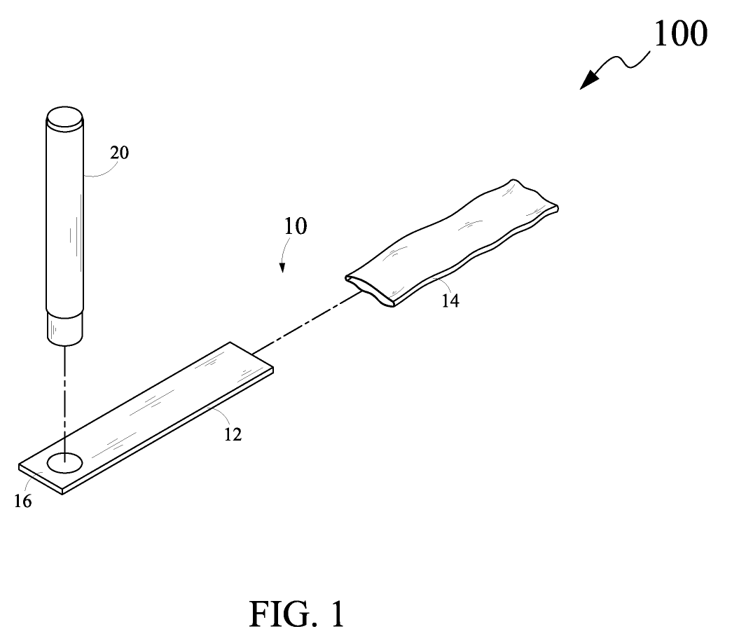

The present disclosure provides a cleaning apparatus that is capable of absorbing water present between an automobile door panel and a door window pane. The cleaning apparatus of the present disclosure will be explained in detail in conjunction with FIGS. 1, 2, and 3.

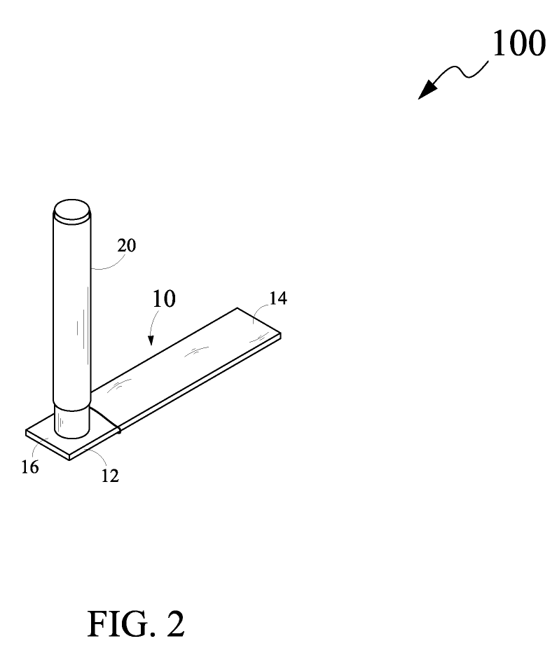

Referring to FIGS. 1 and 2, one embodiment of a cleaning apparatus 100 includes a cleaning member 10 and a handle member 20. FIG. 1 illustrates an exploded view of the cleaning apparatus 100 and FIG. 2 illustrates an assembled view of the cleaning apparatus 100. The cleaning member 10 includes a longitudinal member 12 and an absorbing member 14. The handle member 20 is perpendicularly attached to an end portion 16 of the longitudinal member 12.

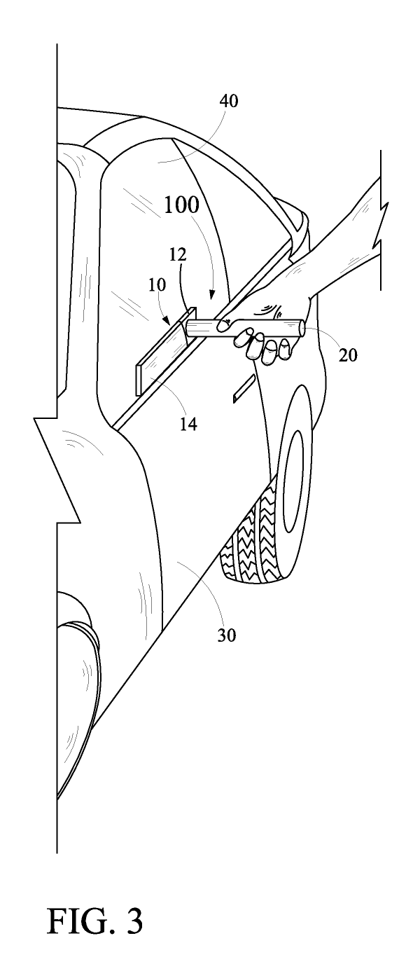

In one form, the longitudinal member 12 has a structural configuration similar to that of a ruler used for measurement. However, the longitudinal member 12 may assume any other structural configuration. In one form, an edge portion of the longitudinal member 12 has a suitable thickness such that the edge portion of the longitudinal member 12 may be inserted between an automobile door panel and a door window pane that is further described in conjunction with FIG. 3. Further, the longitudinal member 12 is made up of a rubber material. However, the longitudinal member 12 may be made up of any other suitable material.

Further, the longitudinal member 12 is wrapped around in the absorbing member 14. Specifically, the absorbing member 14 is capable of wrapping around the longitudinal member 12 and is further capable of absorbing liquids such as water. The absorbing member 14 may be made up of a textile material. However, the absorbing member 14 may be made up of any other material capable of absorbing liquids such as water.

In one form, the handle member 20 is perpendicularly attached to the longitudinal member 12. Specifically, the handle member 20 is attached at the end portion 16 of the longitudinal member 12 thereby forming an “L” shape of the cleaning apparatus 100, as shown in FIG. 2. The handle member 20 is attached to the longitudinal member 12 using a suitable attachment mechanism (not shown). The attachment mechanism may include screws driven through the longitudinal member 12 into the handle member 20 for attaching the handle member 20 to the longitudinal member 12. Alternatively, the attachment mechanism may include any other mechanism known in the art. In another form, the handle member 20 and the longitudinal member 12 may also be preconfigured as a single unit. In the present embodiment of FIGS. 1 and 2, the handle member 20 is shown as cylindrical in shape. However, the handle member 20 may assume any other shape. Further, the handle member 20 may be made up of a light weight material such as wood, a light weight metal, or plastic. The handle member 20 provides a grip to a user for utilizing the cleaning member 10 for absorbing the water present between the automobile door panel and the door window pane, as described in conjunction with FIG. 3.

Referring now to FIG. 3, a perspective view of the cleaning apparatus 100 is shown in a utilized state. The cleaning apparatus 100 absorbs water present between an automobile door panel 30 and a door window pane 40. Specifically, the cleaning member 10, due to its thin edge portions of the longitudinal member 12 is capable of being inserted between the automobile door panel 30 and the door window pane 40. More specifically, a user may hold the cleaning apparatus 100 by the handle member 20 (as shown in FIG. 3) and may insert the cleaning member 10 at point of contact of the automobile door panel 30 and the door window pane 40 for enabling the absorbing member 14 to absorb water therefrom. The user may further move the cleaning apparatus 100 horizontally so that the absorbing member 14 may properly absorb the water present between the automobile door panel 30 and the door window pane 40. This results in clean door window pane 40 when rolled down and up. Alternatively, the cleaning apparatus 100 may also be used by the user to absorb liquid spilled over a surface, to clean glass objects having water stains or for any other cleaning activity that requires absorption of liquid therefrom.

The present disclosure provides a cleaning apparatus, such as the cleaning apparatus 100, which offers the following advantages. The cleaning apparatus has a simple structural configuration and is cost-effective. The cleaning apparatus has a cleaning member and a handle member. The handle facilitates a user to insert the cleaning member between the automobile door panel and the door window pane for enabling the absorbing member to absorb water therefrom. The cleaning apparatus may be moved horizontally along and inside an opening formed between the automobile door panel and the door window pane for enabling the absorbing member to absorb water therefrom. Further, the cleaning apparatus may absorb liquid spilled over a surface, to clean glass objects having water stains or for any other cleaning activity that requires absorption of liquid therefrom.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A cleaning apparatus capable of absorbing water present between an automobile door panel and a door window pane, the cleaning apparatus comprising:
a cleaning member comprising a longitudinal member and an absorbing member capable of wrapping around the longitudinal member, the cleaning member further capable of being inserted between the automobile door panel and the door window pane; and
a handle member perpendicularly attached to the longitudinal member at an end portion of the longitudinal member, the handle member facilitating a user to insert the cleaning member between the automobile door panel and the door window pane for enabling the absorbing member to absorb water therefrom.

2. The cleaning apparatus of claim 1, wherein the handle member is cylindrical in shape.

3. The cleaning apparatus of claim 1, wherein the longitudinal member is made up of a rubber material.
